(19) United States
(12) Patent Application Publication
(10) Pub. No.: US 2007/0051198 A1
(43) Pub. Date: Mar. 8, 2007

(54) Differential gear structure

(76) Inventor: Bor-Yih Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/318,831

(22) Filed: Dec. 28, 2005

Related U.S. Application Data
(63) Continuation-in-part of application No. 11/218,544, filed on Sep. 6, 2005.

(51) Int. Cl. F16H 48/12

(52) U.S. Cl. 74/650

(57) ABSTRACT

A differential gear structure includes a connecting pipe disposed to a transmission shaft, a chamber in the connecting pipe containing first friction plates to accommodate a passive shaft, second friction plates secured to the passive shaft, a blocking seat to hold against the first and the second friction plates for both the transmission shaft and the passive shaft to operate, and a level to move the blocking seat to separate the first and the second friction plates for creating different speeds.

This application is a continuation in part of my application filed Sep. 6, 2005, Ser. No. 11/218,544.

### BACKGROUND OF THE INVENTION

(a) Field of the Invention

The present invention relates to a differential gear structure, and more particularly, to one essentially adapted to an electric mobility scooter having a transmission shaft and a passive shaft connected with first and second friction plates to deliver different speeds with the first and the second friction plates holding against or separating from each other.

(b) Description of the Prior Art

A conventional electric mobility scooter is provided with a power source to drive wheels. A greater turning radius is needed while taking a turn to continue advancing since it is impossible for the wheels to produce different speeds. Saving the different speeds, the electric mobility scooter may be prevented from going ahead, and even may turn over.

### SUMMARY OF THE INVENTION

The primary purpose of the present invention is to provide a differential gear structure to correct the flaws found with the prior art. To achieve the purpose, first friction plates and second friction plates are respectively connected to a transmission shaft and a passive shaft for both shafts to be driven and create different speeds for facilitating the electric mobility scooter to take a turn by having the friction plates to hold against or separate from each other.

The present invention includes a transmission shaft, first friction plates, a passive shaft, second friction plates, a blocking seat, a lever, and a power source in conjunction with a handle bar and a casing. Power is transmitted from the power source to the transmission shaft. One end of transmission shaft is provided with a connecting pipe. The connecting pipe contains a chamber therein and the first friction plates are secured inside the chamber and arranged in a given spacing between two abutted friction plates. Each first friction plate is disposed with a through hole at the center to accommodate one end of the passive shaft. The second friction plates are fixed to the same end of the passive shaft and arranged alternatively in sequence with the first friction plates. A blocking seat containing an elastic member is provided on the passive shaft to hold against the first and the second friction plates, while the first and the second friction plates hold against each other so as to drive the passive shaft at the same time. A flange is disposed to the perimeter of the blocking seat. One end of the lever is pivotally connected to the casing and another end of the lever is made in a fork shape to hold against the flange of the blocking seat. An eccentric block holds against a middle section of the lever to deflect the lever. The eccentric block is pivotally connected to the casing by means of a pivot. The pivot is fixed to a rod. Both sides of the rod are respectively tied with one end of a cable, and the other end of the cable is fixed to a plate. The plate is fixed to an upright post of the handle bar. Once the handle bar is turned, the plate on the upright post rotates to drive the cable, and thus the rod.

One end of the connecting pipe connected to the transmission shaft is provided with a segment gear to engage with another segment gear provided on the power source.

The transmission shaft is a sprocket wheel.

Accordingly, the present invention causes both the transmission shaft and the passive shaft to be driven or produce different speeds to facilitate taking a turn by the electric mobility scooter.

### BRIEF DESCRIPTION OF THE DRAWINGS

FIG. 1 is a cross-sectional view of a preferred embodiment of the present invention.

FIG. 2 is a schematic view showing a rotation block of the preferred embodiment of the present invention.

FIG. 3 is a schematic view showing connection of a handle bar and an eccentric block of the preferred embodiment of the present invention.

FIG. 4 is a schematic view showing an operation of the preferred embodiment of the present invention.

FIG. 5 is a schematic view of another preferred embodiment of the present invention.

### DETAILED DESCRIPTION OF THE PREFERRED EMBODIMENTS

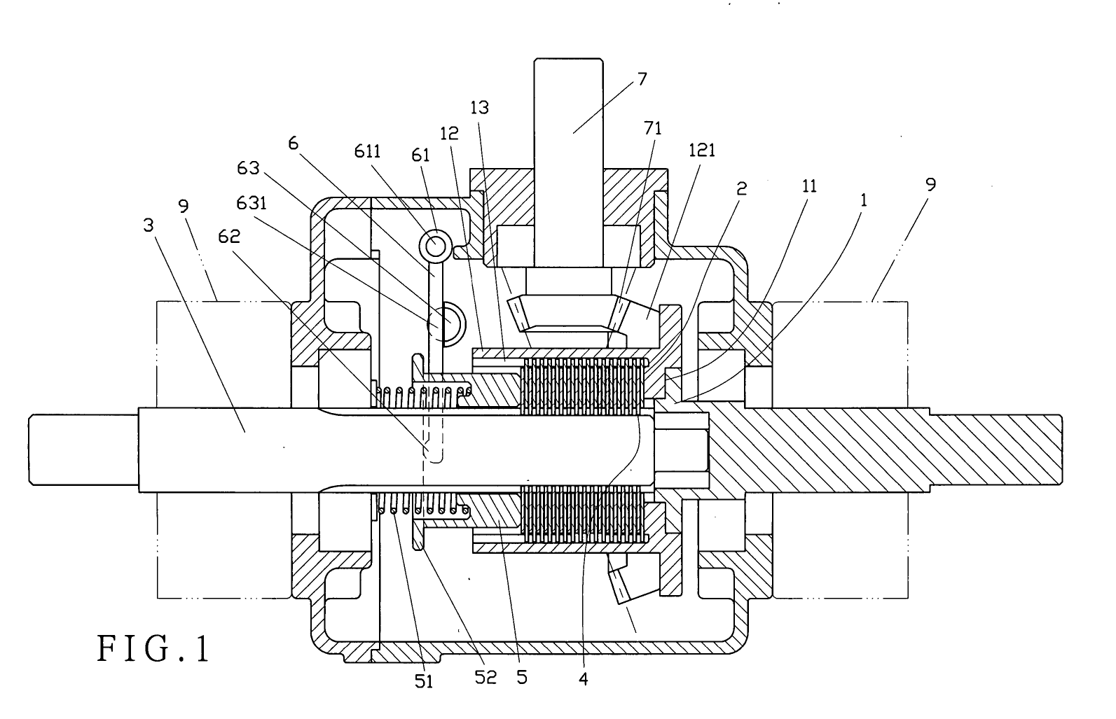

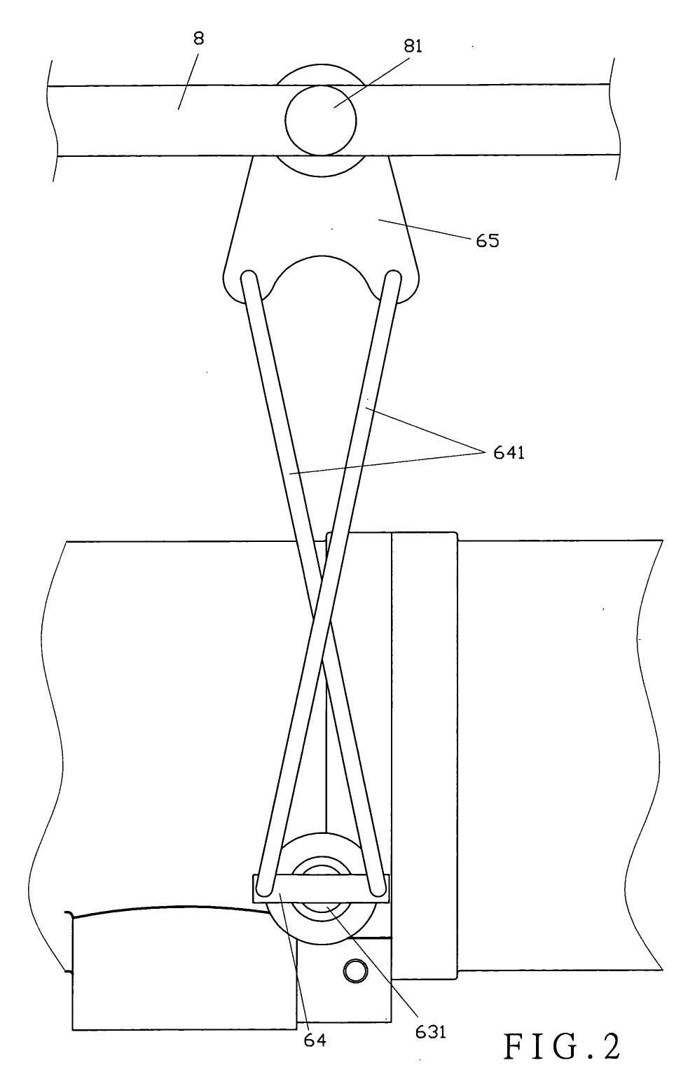

Referring to FIG. 1, a preferred embodiment of the present invention includes a transmission shaft (1), first friction plates (2), a passive shaft (3), second friction plates (4), a blocking seat (5), a lever (6), and a power source (7) (In the drawings, the power source is a power shaft.) in conjunction with a handle bar (8)(as illustrated in FIG. 2) and a casing (related to a prior art and not illustrated), all disposed in the casing with the exception of the handle bar (8). Both the transmission shaft (1) and the passive shaft (3) are respectively pivoted to bearings provided on the casing. Both the transmission shaft (1) and the passive shaft (3) may be modified to extend for an extra length (as illustrated by the broken lines) and a sleeve (9) may be provided on each extension of both the transmission shaft (1) and the passive shaft (3) for mounting a shock absorber (Usually, an absorption system is provided on each of both ends).

One end of the transmission shaft (1) is disposed with a locking end (11) and the locking end (11) is connected with a connecting pipe (12). A segment gear (121) is disposed at the end of the connecting pipe (12) to engage with another segment gear (71) provided on the power source (7). The power is delivered from the power source (7) to the transmission shaft (1). The connecting pipe (12) comprises a chamber (13) therein, and the first friction plates (2) are fixed onto the inner wall edge of the chamber (13) and arranged in a given spacing from one another. A through hole is disposed at the center of each first friction plate (2) to accommodate the passive shaft (3).

One end of the passive shaft (3) penetrates through the through hole of each first friction plate (2) and is fixed with the second friction plates (4). The first friction plates (2) and the second friction plates (4) are arranged alternatively in sequence and flush with each other. The blocking seat (5) is disposed on the passive shaft (3). The blocking seat (5) contains an elastic member (51) therein for the blocking seat (5) to hold against the first friction plates (2) and the second friction plates (4) by taking advantage of the compression force from the elastic member (51). A flange (52) is disposed on the perimeter of the blocking seat (5).

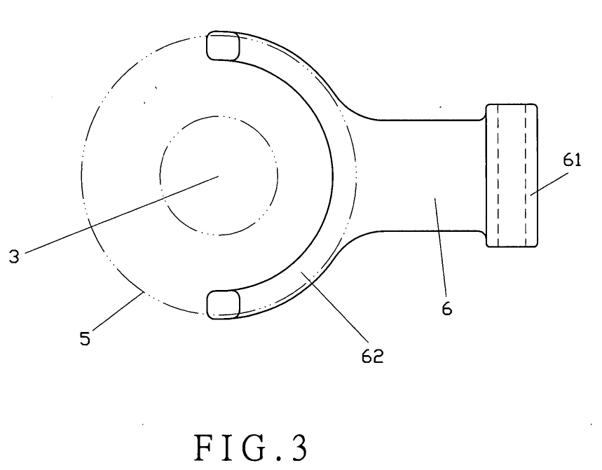

As illustrated in FIG. 3, one end of the lever (6) is provided with a pivoting pipe (61) and another end of the lever (6) is made in a form of a fork (62) to hold against the flange (52) of the blocking seat (5), as illustrated in FIG. 1. A pivot (611) is inserted through the pivoting pipe (61) to pivot the lever (6) to the casing. A middle section of the lever (6) is held against by an eccentric block (63) for the lever (6) to deflect while the eccentric block (63) is connected to the casing by means of another pivot (631), as illustrated in FIG. 2. The pivot (631) is fixedly connected to a rod (64). Both sides of the rod (64) are respectively fastened with one end of a cable (641), and another end of the cable (641) is secured to a plate (65). The plate (65) in turn is secured to an upright post (81) of the handle bar (8).

As illustrated in FIG. 1, the blocking seat (5) holds against the first friction plates (2) and the second friction plates (4) by taking advantage of the compression force from the elastic member (51). Accordingly, the passive shaft (3) is driven simultaneously through the first friction plates (2) and the second friction plates (4) when the power is delivered from the power source (7) to the transmission shaft (1).

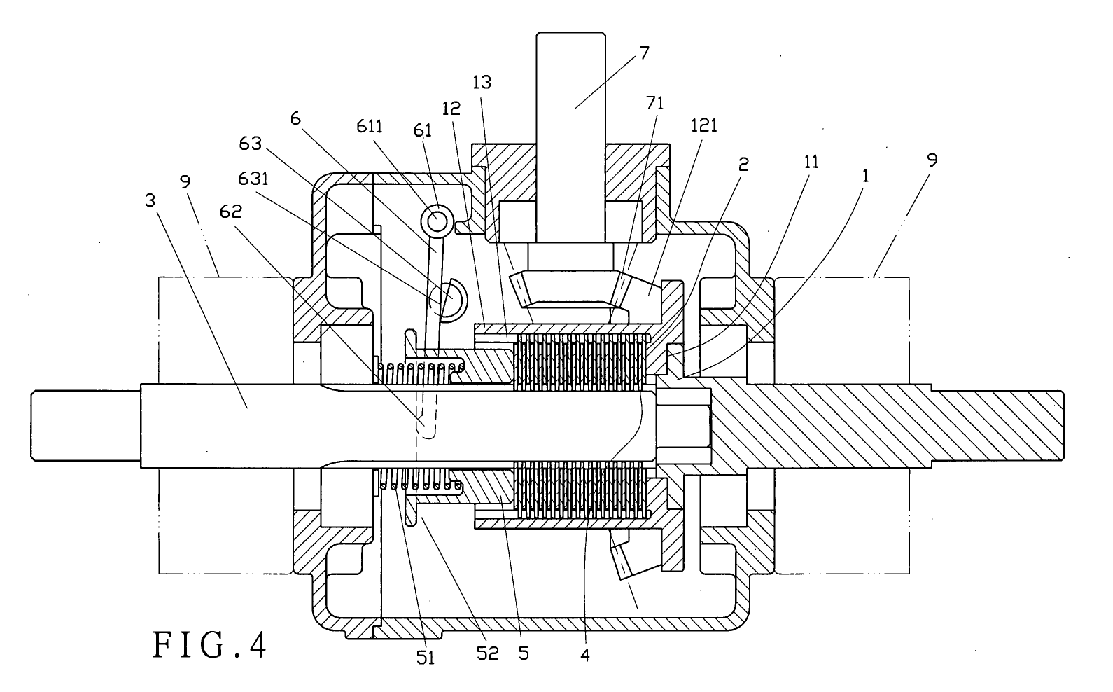

When turning the handle bar (8) for an electric mobility scooter to take a turn, the plate (65) on the upright post (81) rotates to drive the cable (641) and the rod (64) as illustrated in FIG. 2. The eccentric block (63), as illustrated in FIG. 4, is biased to hold against the lever (6) for the fork (62) holding against the flange (52) of the blocking seat (5). The blocking seat (5) in turn shifts to its left to release the second friction plates (4) from holding against the first friction plates (2). Consequently, the passive shaft (3) is not driven so as to reduce its speed to produce difference in speed with that of the transmission shaft (1) to facilitate a smooth turn for the electric mobility scooter.

The transmission pattern applies the same in taking a left or a right turn by the electric mobility scooter. However, during taking a right turn, the turning radius of the passive shaft (3) is greater than that of the transmission shaft (1). Therefore, the angular velocity will cause the speed of the passive shaft (3) to become greater than that of the transmission shaft (1) for completing a smooth right turn.

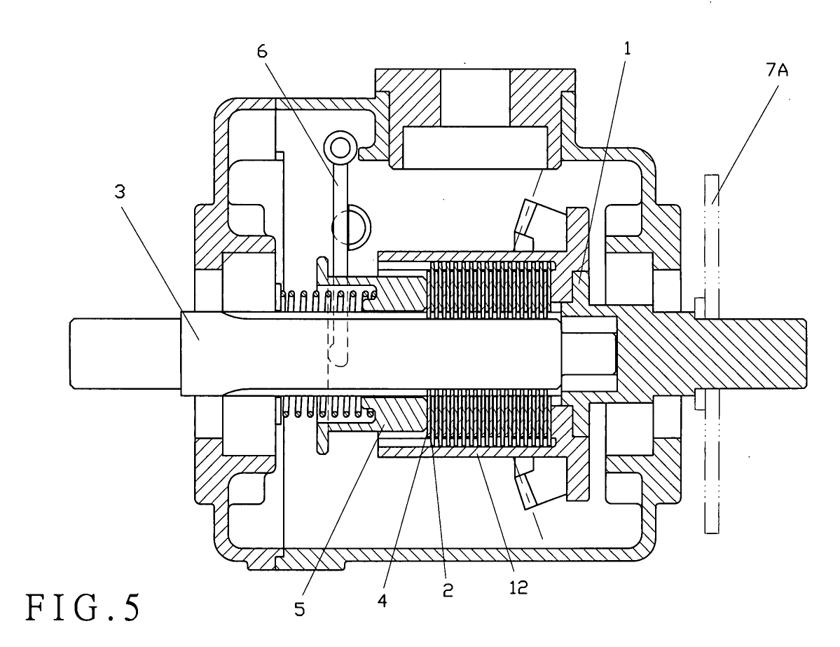

Now referring to FIG. 5, another preferred embodiment of the present invention includes the transmission shaft (1), the first friction plates (2), the passive shaft (3), the second friction plates (4), the blocking seat (5), the lever (6), and a power source (7A). The power source (7A) is a sprocket wheel of the transmission shaft (1) and driven by a chain (not illustrated).

What is claimed is:

1. A differential gear structure including a transmission shaft, first friction plates, a passive shaft, second friction plates, a blocking seat, a lever, and a power source in conjunction with a handle bar and a casing; the power source transmitting power to the transmission shaft; one end of the transmission shaft being connected with a connecting pipe; the connecting pipe containing a chamber therein; the first friction plates being fixed in the chamber separating from one another at a given spacing; a through hole being disposed at the center of each first friction plate to receive one end of the passive shaft; the second friction plates being fixed to the end of the passive shaft separating from one another at a given spacing; each second friction plate and each first friction plate being alternatively arranged in sequence; the blocking seat being disposed on the passive shaft and comprising an elastic member therein; the blocking seat holding against the first friction plates and the second friction plates by means of the elastic member; the first friction plates and the second friction plates being held against each other for the passive shaft to be driven simultaneously with the transmission shaft; a flange being disposed on the blocking seat; one end of the lever being pivotally connected to the casing; another end of the lever being made in a fork shape to hold against the flange of the blocking seat; an eccentric block holding against a middle section of the lever to deflect the lever; the eccentric block being pivotally connected to the casing by means of a pivot; the pivot being fixed to a rod; both sides of the rod being respectively penetrated through and fixed with one end of a cable; another end of the cable being fixed to a plate; the plate being fixed to an upright post of the handle bar; and the plate on the upright post driving the cable to further drive the rod when the handle bar is turned.

2. The differential gear structure of claim 1, wherein one end of the connecting pipe connected to the transmission shaft is provided with a segment gear to engage with another segment gear provided on the power source.

3. The differential gear structure of claim 1, wherein the transmission shaft is a sprocket wheel.
